(19) United States
(12) Patent Application Publication
(10) Pub. No.: US 2003/0126218 A1
(43) Pub. Date: Jul. 3, 2003

(54) Unsolicited commercial e-mail rejection setting method and e-mail apparatus using the same

(75) Inventor: Toshiyuki Sakonsaku, Kanagawa (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/318,710

(22) Filed: Dec. 13, 2002

(30) Foreign Application Priority Data
Dec. 28, 2001 (JP) 398814/2001

(51) Int. Cl. G06F 15/16

(52) U.S. Cl. 709/206

(57) ABSTRACT

An unsolicited commercial e-mail rejection setting method of this invention includes the steps of comparing an e-mail address of incoming e-mail with e-mail addresses stored in storage means, and setting e-mail rejection with respect to the e-mail address of the incoming e-mail if the e-mail address of the incoming e-mail coincides with none of the e-mail addresses stored in the storage means. In this unsolicited commercial e-mail rejection setting method, e-mail rejection setting can be made after a user is asked whether he/she sets e-mail rejection with respect to incoming e-mail.

### BACKGROUND OF THE INVENTION

1. Field of the Invention

The present invention relates to an unsolicited commercial e-mail rejection setting method which can easily set unsolicited commercial e-mail rejection, and an e-mail apparatus using the method.

2. Description of the Prior Art

Nowadays, e-mail is exchanged through cellular telephone sets, personal computers, and the like. Unsolicited commercial e-mail is sent to users without permission. Some telephone companies charge users when they only receive unsolicited commercial e-mail, thus posing a problem. As a method of rejecting the reception of unsolicited commercial e-mail, a method is executed which inhibits the transmission of unsolicited commercial e-mail by accessing an unsolicited commercial e-mail prevention site of a corresponding telephone company or provider and registering e-mail addresses from which the reception of e-mail is rejected.

According to this e-mail rejection setting method, however, a user must retain or store the address of unsolicited commercial e-mail, and then inputs the address of the unsolicited commercial e-mail to a corresponding telephone company or the like after opening a predetermined site. It takes much labor and time to register the address.

Even if e-mail rejection settings are done, the source of unsolicited commercial e-mail can repeatedly transmit unsolicited commercial e-mail by slightly changing its e-mail address. Every time such unsolicited commercial e-mail is received, the user must notify the telephone company or the like of the e-mail address of the unsolicited commercial e-mail. It is therefore difficult to completely reject the reception of unsolicited commercial e-mail that is transmitted with a slight change in e-mail address.

### SUMMARY OF THE INVENTION

The present invention has been made to solve the above problems, and has as its object to provide a method of easily setting unsolicited commercial e-mail rejection, and an e-mail apparatus using the method.

In order to achieve the above object, according to an aspect of the present invention, upon reception of e-mail, a communication apparatus, e.g., a cellular telephone set, checks whether the e-mail address of the e-mail has stored in the storage section of the cellular telephone set, e.g., an address book, or checks from a log of e-mail whether the e-mail was received and opened in the past. If the e-mail address of the incoming e-mail is recorded on the address book or coincides with the main address of e-mail that was opened in the past, the e-mail is held to be opened in the usual way. If the e-mail address of the incoming e-mail coincides with none of the e-mail addresses recorded on the address book or log of e-mail, e-mail rejection is set with respect to e-mail from this e-mail address.

According to another aspect of the present invention, e-mail rejection can be set after the user is asked whether he/she sets e-mail rejection with respect to incoming e-mail. In this case, when the user determines from the tile, e-mail address, and the like of e-mail that the incoming e-mail is extraneous, unsolicited commercial e-mail, he/she can set e-mail rejection.

If the incoming e-mail is not unsolicited commercial e-mail, the user can open the incoming e-mail. If the incoming e-mail is unsolicited commercial e-mail and the user is to set e-mail rejection, he/she starts transmitting operation to transmit information indicating e-mail rejection to the server, thereby making settings to inhibit the transmission of e-mail from such an e-mail address.

According to this method, the user can set e-mail rejection with respect to e-mail from a specific e-mail address by only answering simple questions with “YES” and “NO” through the cellular telephone set.

In addition, the user may set e-mail rejection by designating not only an e-mail address but also a domain name. With this setting, even if a sender transmits unsolicited commercial e-mail while slightly changing its e-mail address, e-mail rejection can be effectively done. Furthermore, a password may be input before e-mail rejection setting. With this operation, the user can prevent the third party from making unwanted settings.

As described above, according to the unsolicited commercial e-mail rejection setting method and e-mail apparatus of the present invention, unsolicited commercial e-mail is checked on the basis of an address book or a log of e-mailing operations. In addition, unsolicited commercial e-mail can be easily specified, and the user can easily make e-mail rejection settings with respect to the server without the need for opening a specific site and inputting the e-mail addresses of unsolicited commercial e-mail one by one.

The above and many other objects, features and advantages of the present invention will become manifest to those skilled in the art upon making reference to the following detailed description and accompanying drawings in which a preferred embodiment incorporating the principle of the present invention is shown by way of an illustrative example.

### BRIEF DESCRIPTION OF THE DRAWINGS

FIG. 1 is a block diagram showing the schematic arrangement of an e-mail system which executes an unsolicited commercial e-mail rejection setting method according to the present invention; and

FIG. 2 is a flow chart showing operation for unsolicited commercial e-mail rejection settings.

### DETAILED DESCRIPTION OF THE PREFERRED EMBODIMENT

An unsolicited commercial e-mail rejection setting method and an e-mail apparatus according to the present invention will be described below with reference to the accompanying drawings.

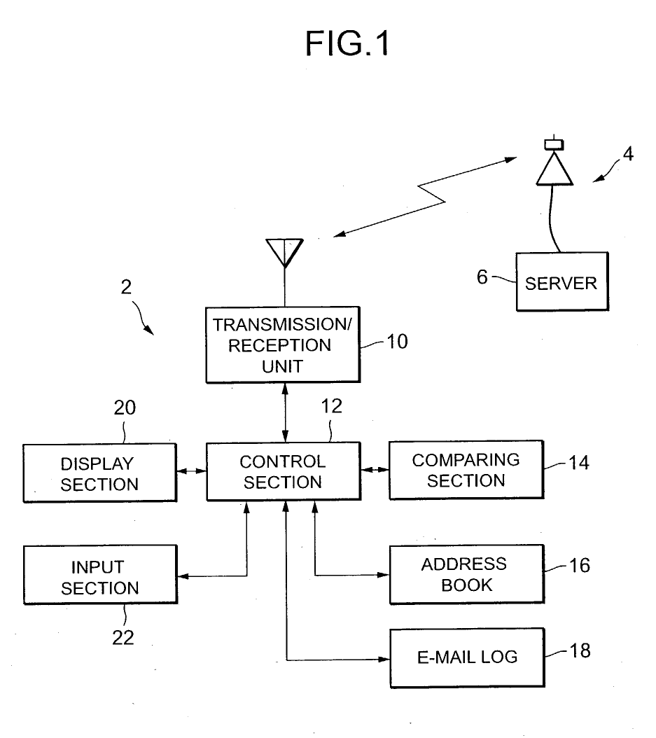

FIG. 1 shows a cellular telephone set 2 as an e-mail apparatus and a base station 4 as a relay base. The cellular telephone set 2 has an e-mail function in addition to a general speech communication function. The e-mail function is performed through a server 6.

The cellular telephone set 2 includes a display section 20 formed of a liquid crystal or the like, an input section 22 such as an operation button, an address book 16 on which the user records names, addresses, and e-mail addresses in advance, and an e-mail log 18 which stores the information of e-mail transmitted/received in the past. In addition, the cellular telephone set 2 includes a comparing section 14 which compares, upon reception of e-mail, the e-mail address of the incoming e-mail with the e-mail addresses input to the address book 16 and e-mail log 18, a control section 12 which controls the overall cellular telephone set 2 and transmits the e-mail address of e-mail for which e-mail rejection setting is done to the server 6 through a transmission/reception unit 10.

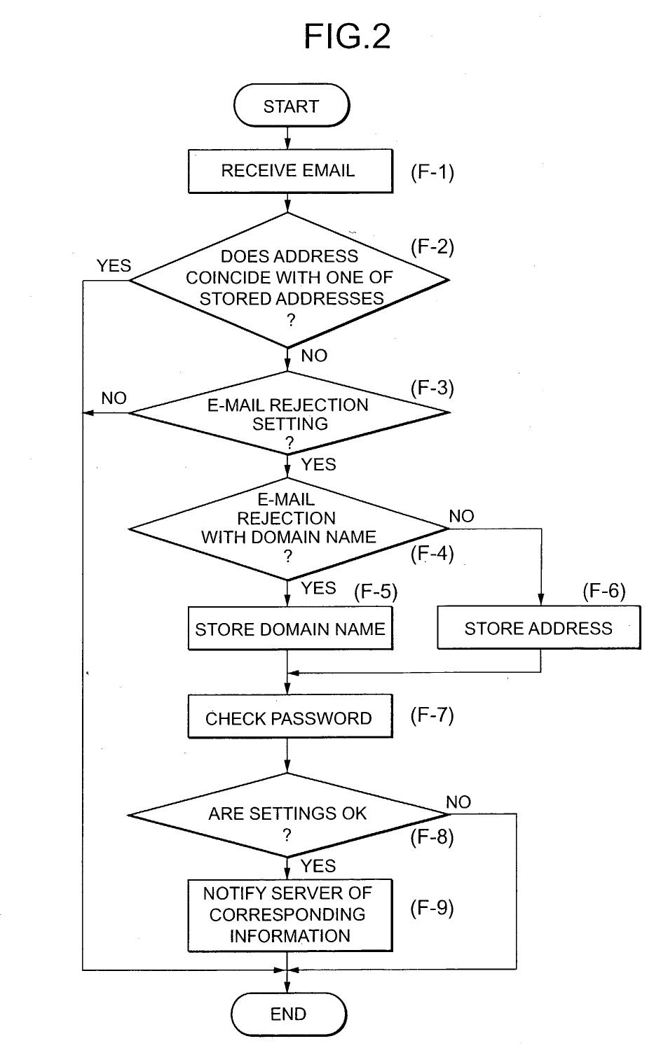

Unsolicited commercial e-mail rejection setting operation in the cellular telephone set 2 will be described next with reference to the flow chart of FIG. 2.

When e-mail is received (F-1), the display section 20 displays information indicating that the e-mail has been received. In addition, the e-mail address of the incoming e-mail is read, and the comparing section 14 compares the read address with the e-mail addresses recorded on the address book 16 and e-mail log 18, thereby checking whether the e-mail address of the incoming e-mail coincides with one of the recorded addresses (F-2). If it is determined that the e-mail address of the incoming e-mail coincides with one of the recorded e-mail addresses, normal e-mail receiving operation is performed.

If the e-mail address of the incoming e-mail coincides with none of the recorded e-mail addresses, the user who tries to open this e-mail is notified of the corresponding information and is asked whether he/she sets e-mail rejection with respect the e-mail address of this e-mail (F-3). The display section 20 of the cellular telephone set 2 displays information indicating that the e-mail address of the information e-mail has not been recorded before, and the user opens the incoming call if he/she has an idea about who has sent the e-mail, on the basis of the address, title, and the like of the e-mail. In contrast, if the user has no ideal about the incoming e-mail, he/she determines that the incoming e-mail is unsolicited commercial e-mail, and operates the input section 22 to set e-mail rejection. This operation is done by, for example, selecting “YES” or “NO” displayed on the display section 20.

When e-mail rejection setting is selected in the cellular telephone set 2, the user is asked whether he/she sets e-mail rejection with its domain name (F-4). In general, unsolicited commercial e-mail often uses a domain name that is not generally used. If, therefore, the user determines that his/her friends and the like do not use such a domain name, he/she sets the domain name as an e-mail rejection target. If the user sets the e-mail address as an e-mail rejection target, he/she stores the e-mail address (F-6). If the user sets the domain name as an e-mail rejection target, he/she stores the domain name (F-5).

A password or the like is then input (F-7), and the settings that have been made are finally checked (F-8) If it is determined that the settings are OK, e-mail rejection is set with respect to the e-mail address or domain name of the incoming e-mail. If e-mail rejection is set by the cellular telephone set 2, an outgoing call is automatically generated to transmit, to the server, information indicating that the e-mail is rejected, together with the e-mail address or domain name (F-9).

The server operates in accordance with the instruction from the user, and stops transmitting any e-mail from the set specific e-mail address or the like to the user in the future. Note that information indicating e-mail rejection may not automatically be transmitted to the server but may be stored to be transmitted at the same time when the user generates an outgoing call next or may be transmitted in accordance with operation by the user.

Although the above embodiment has exemplified the cellular telephone set 2, the unsolicited commercial e-mail rejection setting method according to the present invention is not limited to cellular telephone sets and may be used for any types of apparatuses, devices, and the like, such as wire telephone sets and personal computers as long as they handle e-mail.

What is claimed is:

1. An unsolicited commercial e-mail rejection setting method comprising the steps of comparing an e-mail address of incoming e-mail with e-mail addresses stored in storage means, and setting e-mail rejection with respect to the e-mail address of the incoming e-mail if the e-mail address of the incoming e-mail coincides with none of the e-mail addresses stored in the storage means.

2. An unsolicited commercial e-mail rejection setting method comprising the steps of comparing an e-mail address of incoming e-mail with e-mail addresses stored in storage means, asking a user whether to set e-mail rejection with respect to the e-mail address of the incoming e-mail if the e-mail address of the incoming e-mail coincides with none of the e-mail addresses stored in the storage means, and setting e-mail rejection if the user answers that e-mail rejection is set.

3. A method according to claim 1, wherein the storage means comprises an address book.

4. A method according to claim 2, wherein the storage means comprises an address book.

5. A method according to claim 1, wherein the storage means comprises an address book and a log of incoming e-mail.

6. A method according to claim 2, wherein the storage means comprises an address book and a log of incoming e-mail.

7. A method according to claim 1, wherein the e-mail rejection setting is made by using a domain name of unsolicited commercial e-mail.

8. A method according to claim 2, wherein the e-mail rejection setting is made by using a domain name of unsolicited commercial e-mail.

9. A method according to claim 1, wherein a password of a user is checked before the e-mail rejection setting is made.

10. A method according to claim 2, wherein a password of a user is checked before the e-mail rejection setting is made.

11. An e-mail apparatus comprising comparing means for comparing an e-mail address of incoming e-mail with e-mail addresses stored in storage means, and control means for asking a user whether to set e-mail rejection with respect to the e-mail address of the incoming e-mail if the e-mail address of the incoming e-mail coincides with none of the e-mail addresses stored in the storage means, and setting e-mail rejection if the user answers that e-mail rejection is set.
